(19) United States
(12) Patent Application Publication
(10) Pub. No.: US 2024/0249145 A1
(43) Pub. Date: Jul. 25, 2024

(54) SYSTEMS AND METHODS FOR ADAPTIVE CONFORMAL PREDICTION

(71) Applicant: Salesforce, Inc., San Francisco, CA (US)

(72) Inventor: Aadyot Bhatnagar, Palo Alto, CA (US)

(21) Appl. No.: 18/308,429

(22) Filed: Apr. 27, 2023

Related U.S. Application Data
(60) Provisional application No. 63/481,564, filed on Jan. 25, 2023.

(51) Int. Cl. G06N 3/084

(52) U.S. Cl. CPC G06N 3/084

(57) ABSTRACT

Embodiments described herein provide a Strongly Adaptive Online Conformal Prediction (SAOCP) framework that manages multiple experts each for predicting a respective prediction radius, while each expert only operates on its own active interval. An aggregated prediction radius may be computed as a weighted sum of the predicted radii, each weighted by the respective probability that the respective expert is active at the time step. Specifically, each expert may be operated with a Scale-Free OGD (SF-OGD) method to update the generated predicted radius. A base conformal predictor may then generate a prediction set using the aggregated radius at the time step.

### CROSS REFERENCES

The application is a nonprovisional of and claims priority under 35 U.S.C. 119 to co-pending and commonly-owned U.S. provisional application No. 63/481,564, filed Jan. 25, 2023, which is hereby expressly incorporated by reference herein in its entirety.

### TECHNICAL FIELD

The embodiments relate generally to natural language processing and machine learning systems, and more specifically to an online conformal prediction method.

### BACKGROUND

Machine learning systems have been widely used in decision making, for example, outputting predictions using past experience such as weather forecasting, power usage forecasting, and/or the like. In high stakes decision-making tasks, machine learning systems would not only provide the predictions, but also quantify a certainty level of these predictions. Conformal prediction is one of the tools for quantifying uncertainties for predictions, to generate prediction sets that associate each input with a set of candidate labels, such as prediction intervals for regression, and label sets for classification. In an online setting where the data distribution may vary arbitrarily over time, online conformal prediction techniques may be adopted to leverage regret minimization algorithms to learn prediction sets with approximately valid coverage and small regret. However, in regard to uncertainty quantification, traditional regret minimization could be insufficient for handling changing environments, where performance guarantees may be desired not only over the full time horizon but also in all (sub-)intervals of time.

Therefore, there is a need for improving online conformal prediction.

### BRIEF DESCRIPTION OF THE DRAWINGS

FIG. 1 is an example block diagram illustrating a strongly adaptive online conformal prediction (SAOCP) network, according to embodiments described herein.

FIG. 2A is an example pseudo code segment illustrating an operation of the SAOCP framework shown in FIG. 1, and

FIGS. 2B-2C provides an example logic flow diagram illustrating a method of adaptive online conformal predicting based on the SAOCP framework, according to some embodiments described herein.

FIG. 3A is an example pseudo code segment illustrating an operation of the Scale-Free Online Gradient Descent (SF-OGD) method for initializing each online radius predictor, and

FIG. 3B provides an example logic flow diagram illustrating a method of generating a next predicted radius for the next timestep based on the SF-OGD, according to some embodiments described herein.

FIG. 4 is a simplified diagram illustrating a computing device implementing a the SAOCP framework described herein in FIGS. 1-3B, according to one embodiment described herein.

FIG. 5 is a simplified block diagram of a networked system suitable for implementing the strongly adaptive online learning framework described in FIG. 1 and other embodiments described herein.

FIG. 6 is a simplified diagram illustrating aspects of applying the SAOCP framework to time series forecasting, according to embodiment described herein.

FIG. 7 is a simplified diagram illustrating aspects of applying the SAOCP framework to image classification under distribution shift, according to embodiment described herein.

FIGS. 8-9 provide example data performance of time series forecasting using SAOCP framework illustrated in FIG. 6, according to embodiments described herein.

FIG. 10 is an example data plot illustrating the data performance of image classification using SAOCP framework, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Conformal prediction is one of the tools for quantifying uncertainties for predictions, to generate prediction sets that associate each input with a set of candidate labels, such as prediction intervals for regression, and label sets for classification. For example, for training examples (x, y) E [symbol] × [symbol] to predict a label y from input x. A conformal predictor generates a prediction set C: [symbol] →2^{y}, which is a set-valued function that maps any input x to a set of predicted labels C(x)⊂ [symbol] . Two prevalent examples are prediction intervals for regression in which [symbol] = [symbol] and C (x) is an interval, and label prediction sets for (m-class) classification in which [symbol] =[m] and C(x) is a subset of [m]. Prediction sets are a popular approach to quantify the uncertainty associated with the point prediction ŷ=f(x) of a black box model, e.g., in weather forecasts, power usage forecasts, market forecasts, and/or the like. Conformal prediction may be applied to compute the best and worst scenarios to help in making sensible decisions.

Specifically, when data arrives in a sequential order, conformal prediction may be applied in an online fashion with the sequentially received data input. At each time step, the online conformal predictor outputs a prediction set parameterized by a single radius parameter that controls the size of the set. After receiving the true label, the predictor adjusts this parameter adaptively via regret minimization techniques-such as Online Gradient Descent (OGD) on a certain quantile loss over the radius. These methods are shown to achieve empirical coverage frequency close to 1−α, regardless of the data distribution, with a being a target coverage level.

While traditional regret minimization techniques achieve coverage and regret guarantees, they may fall short in more dynamic environments where a strong performance not just over the entire time horizon (as captured by the regret), but also within every sub-interval of time. For example, if the data distribution shifts abruptly for a few times, strong performance is desired within each contiguous interval between two consecutive shifts, in addition to the entire horizon. Some existing systems adopt the Fully Adaptive Conformal Inference (FACI) algorithm, a meta-algorithm that aggregates multiple experts (base learners) that are OGD instances with different learning rates. However, these methods may not be best suited for achieving such interval-based guarantees, as each expert still runs over the full time horizon and is not really localized. In other words, regret minimization is limited as the regret measures performance over the entire time horizon [T], which may be insufficient when the algorithm encounters changing environments. For example, when the “true radius” of the prediction set, e.g., (i. e. the smallest radius s such that the prediction set at time t: Ĉₜ covers Yₜ), Sₜ:=inf{s∈ [symbol] : Yₜ∈Ĉₜ (Xₜ, s)}, 1 for 1≤T/2 and Sₜ=100 for T/2<t≤T, then achieving small regret on all (sub)-intervals of size T/2 is a much stronger guarantee than achieving small regret over [T]. This is also reflected in the fact that FACI achieves a near-optimal [symbol] (√k) regret within intervals of a fixed length k, but is unable to achieve this over all lengths k∈[T] simultaneously. For this reason, localized guarantees over all intervals simultaneously are desired, to prevent worst-case scenarios such as significant miscoverage or high radius within a specific interval.

In view of the need for learning prediction sets with a valid coverage and small regret in response to the online setting, embodiments described herein provide a Strongly Adaptive Online Conformal Prediction (SAOCP) framework that manages multiple experts each for predicting a respective prediction radius, while each expert only operates on its own active interval. An aggregated prediction radius may be computed as a weighted sum of the predicted radii, each weighted by the respective probability that the respective expert is active at the time step. Specifically, each expert may be operated with a Scale-Free OGD (SF-OGD) method to update the generated predicted radius. A base conformal predictor may then generate a prediction set using the aggregated radius at the time step.

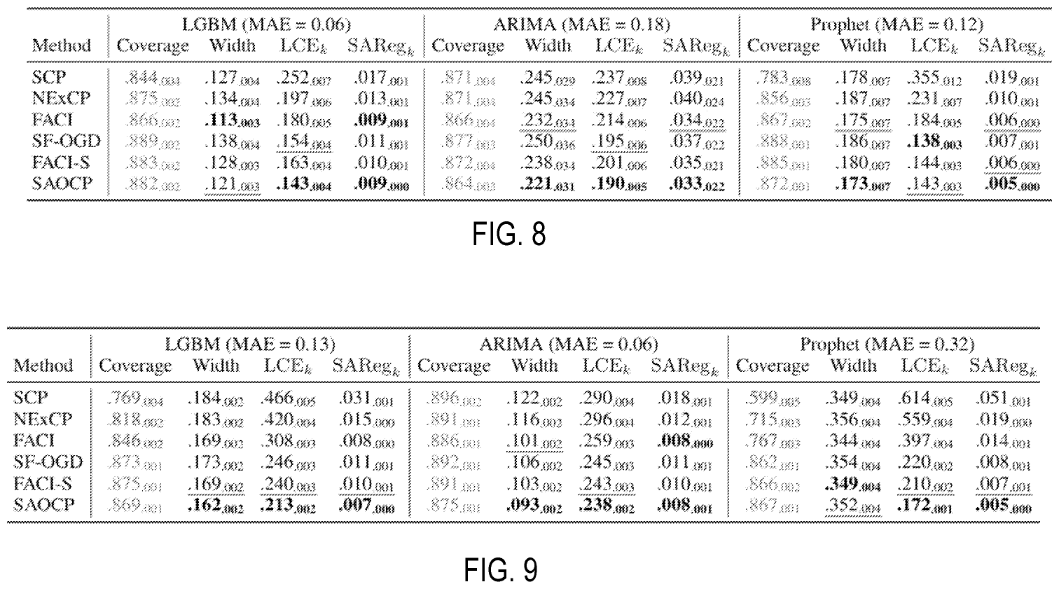

In this way, the SAOCP framework achieves a near-optimal strongly adaptive regret of [symbol] (√k) regret over all intervals of length k simultaneously, and that both SAOCP and SF-OGD achieve approximately valid coverage. Accuracy of prediction is largely improved. Furthermore, the online conformal prediction method consistently attains better coverage and smaller prediction sets on real-world tasks, such as time series forecasting and image classification under distribution shift, as further illustrated in FIGS. 8-10.

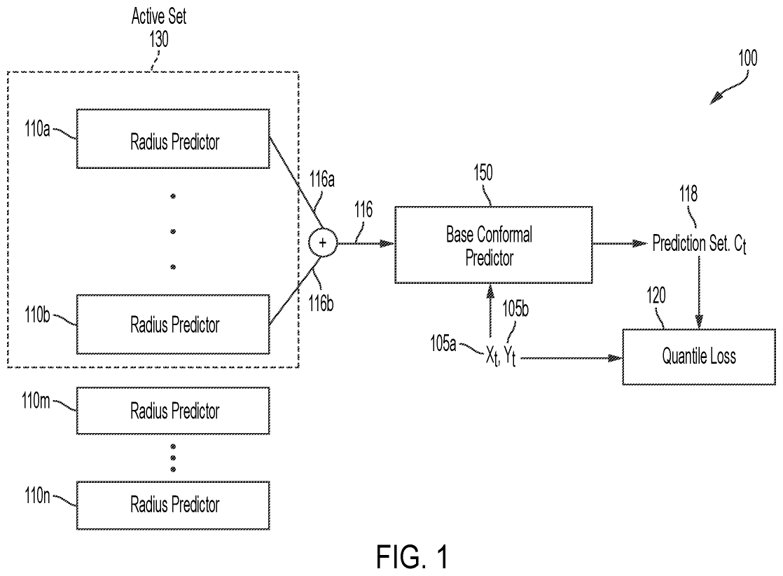

FIG. 1 is an example block diagram illustrating a strongly adaptive online conformal prediction (SAOCP) network 100, according to embodiments described herein. The SAOCP framework 100 comprises a set of radius predictors, “experts” 110a-n and a base conformal predictor 150. Each radius predictor 110a-n and the base conformal predictor 150 may be neural network based models implemented on one or more hardware processors. Specifically, the SAOCP framework 100 implements a meta-algorithm that manages multiple online radius predictor (experts) 110a-n, where each expert itself implements an arbitrary online learning algorithm taking charge of its own active interval that has a finite lifetime.

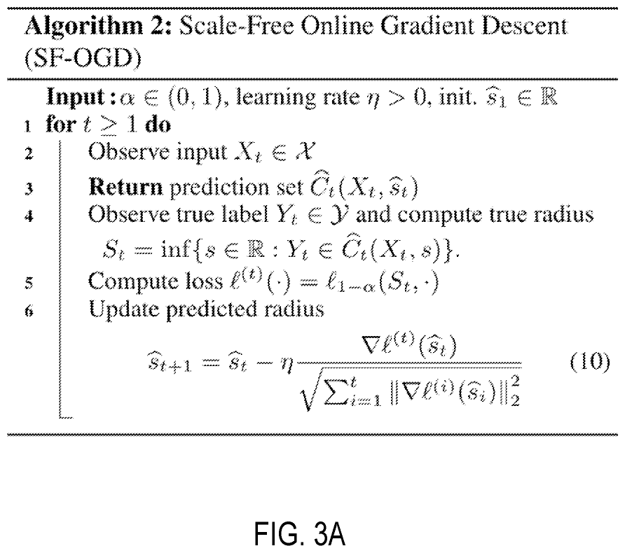

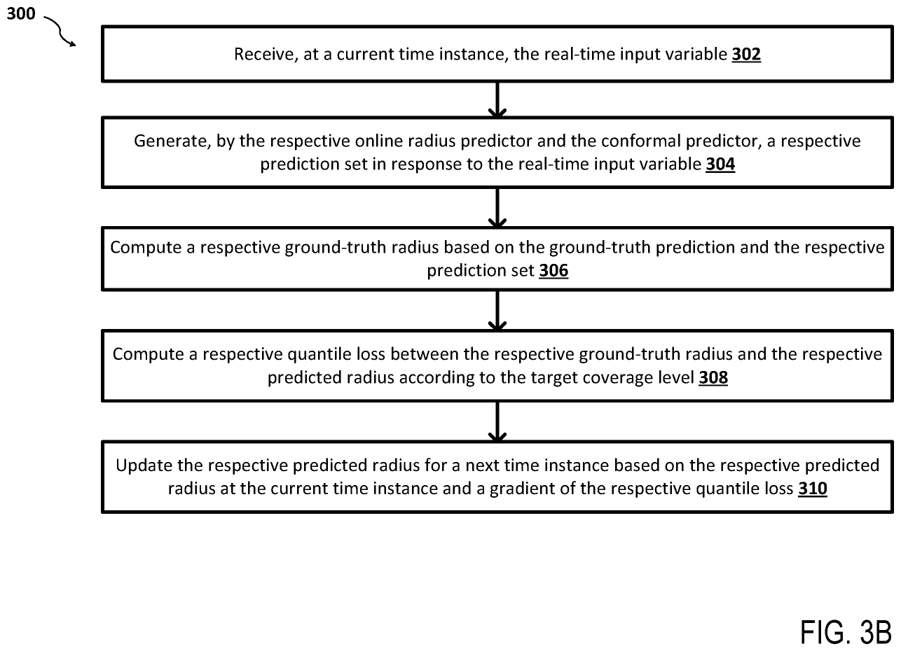

In one embodiment, each radius predictor 110a-n may implement a Scale-Free OGD (SF-OGD) that decays its effective learning rate based on cumulative past gradient norms, as further described in relation to FIGS. 3A-3B. It is noted that the SAOCP framework 100 may employ any type of radius predictor that is a good regret minimization algorithm over its own active interval satisfying anytime regret guarantees.

In one embodiment, online samples (X₁Y₁), . . . , (X_{T}Y_{T}) may arrive sequentially. At each time step t∈[T], the online sample of input Xₜ 105a and the corresponding output label Yₜ 105b may be observed. A new radius predictor [symbol] ₜ may be instantiated with an active interval [t, t+L(t)−1], where L(t) is its lifetime:

$$L ( t ) := g \cdot {max}_{n ∈ ℤ} \{ {2}^{n} : t ≡ 0 mod {2}^{n} \} \qquad ( 1 )$$

and g∈ [symbol] _{≥1} is a multiplier for the lifetime of each expert 110a-n. Therefore, at time t, an active set 130 of radius predictor 110a-b may be determined. It is noted that the number of radius predictors 110a-n, and/or the number of active radius predictor 110a-b at time t are for illustrative purpose only, and any number of (active) radius predictors may be engaged. It is also noted that most g└log₂t┘ experts are active at any time t under choice (1), granting the SAOCP framework 100 a total runtime of [symbol] (T log T) for any g=Θ(1), which improves system efficiency.

In one embodiment, at each time t∈[T], each radius predictor 110a-b in the active set 130 may generate a predicted radius parameter 116a-b, respectively, at the time step, e.g., ŝ_{i,t}∈ [symbol] where i represents the ith active radius predictor. Then, at any time t, the predicted radius ŝₜ 116 is obtained by aggregating the predictions of active radius predictors 110a-b:

$${\hat{s}}_{t} = {\sum }_{i ∈ Active ( t )} {p}_{i} , t {\hat{s}}_{i , t} , \qquad ( 2 )$$

where the weights{p_{i,t}}_{i∈[t]} rely on the {w_{i,t}}_{i∈[t]} computed by the coin betting scheme, as further described at lines 4-6 of Alg. 1 in 2A FIG.

Given the predicted radius ŝₜ, the base conformal predictor 150 generates a prediction set Ĉₜ=Ĉₜ(Xₜ) 118 based on the current input Xₜ 105a and past observations {(Xᵢ,Yᵢ)}_{i≤t-1}, before observing the true label Yₜ. For example, over the time interval, the family (Cₜ)_{t∈[T] is generated through one or more base predictors 150 (for example, \hat{f}}ₜ (for example, \hat{f}ₜ=f can be a fixed pretrained model). The base conformal predictor 150 in regression is a base predictor \hat{f}ₜ: [symbol] → [symbol] , and choose Ĉₜ(Xₜ,s):=[\hat{f}ₜ(Xₜ)−s, \hat{f}ₜ(Xₜ)+s] to be a prediction interval around \hat{f}ₜ(Xₜ), in which case the radius s is the (half) width of the interval. In one example, Cₜ 118 are nested sets in the sense that Ĉₜ(x, s)⊆Ĉₜ(x, s′) for all x∈ [symbol] and s≤s′, so that a larger radius always yields a larger set.

An example property of the prediction set 118 is to achieve valid coverage: [symbol] [Yₜ∈Ĉₜ (Xₜ)]=1−α, where 1−α∈(0,1) is the target coverage level pre-determined by the user. Example choices for α include {0.1, 0.05}, which correspond to {90%, 95%} target coverage respectively.

In one embodiment, the SAOCP framework 100 adopts online learning techniques to learn the predicted radius ŝₜ based on past observations. For example, defining the “true radius” Sₜ:=inf{s∈ [symbol] :Yₜ∈Ĉₜ(Xₜ, s)} (i.e. the smallest radius s such that Ĉₜ covers Yₜ), the (1−α)-quantile loss 120 between Sₜ and any predicted radius ŝ by the active radius predictor 110a-b is computed by:

$${ℓ}^{t} ( \hat{s} ) = {ℓ}_{1 - α} ( {S}_{t} , \hat{s} ) := max \{ ( 1 - α ) ( {S}_{t} - \hat{s} ) , α ( \hat{s} - {S}_{t} ) \} . \qquad ( 3 )$$

It is assumed that all true radii are bounded: Sₜ∈[0, D] almost surely for all t∈[T].

Therefore, after observing input Xₜ 105a, predicting the radius ŝₜ 116, and observing the label Yₜ 105b (and hence computing the true radius Sₜ), the gradient ∇ [symbol] ^{(t)} (ŝₜ) of the quantile loss 120 can be computed as:

$$∇ {ℓ}^{( t )} ( {\hat{s}}_{t} ) = α - 1 [ {\hat{s}}_{t} < {S}_{t} ] = α - {\underbrace{1 [ {Y}_{t} ∉ {\hat{C}}_{t} ]}}_{:= {err}_{t}} , \qquad ( 4 )$$

where errₜ is the indicator of miscoverage at time t(errₜ=1 if Ĉₜ did not cover Yₜ). An Online Gradient Descent (OGD) step is performed to obtain ŝₜ₊₁:

$${\hat{s}}_{t + 1} = {\hat{s}}_{t} - η ∇ {ℓ}^{( t )} ( {\hat{s}}_{t} ) = {\hat{s}}_{t} + η ( e r {r}_{t} - α ) , \qquad ( 5 )$$

where η>0 is a learning rate, and the algorithm is initialized at some ŝ₁∈ [symbol] . Update (3) increases the predicted radius if Ĉₜ did not cover Yₜ (errₜ=1), and decreases the radius otherwise. This makes intuitive sense as an approach for adapting the radius to recent observations.

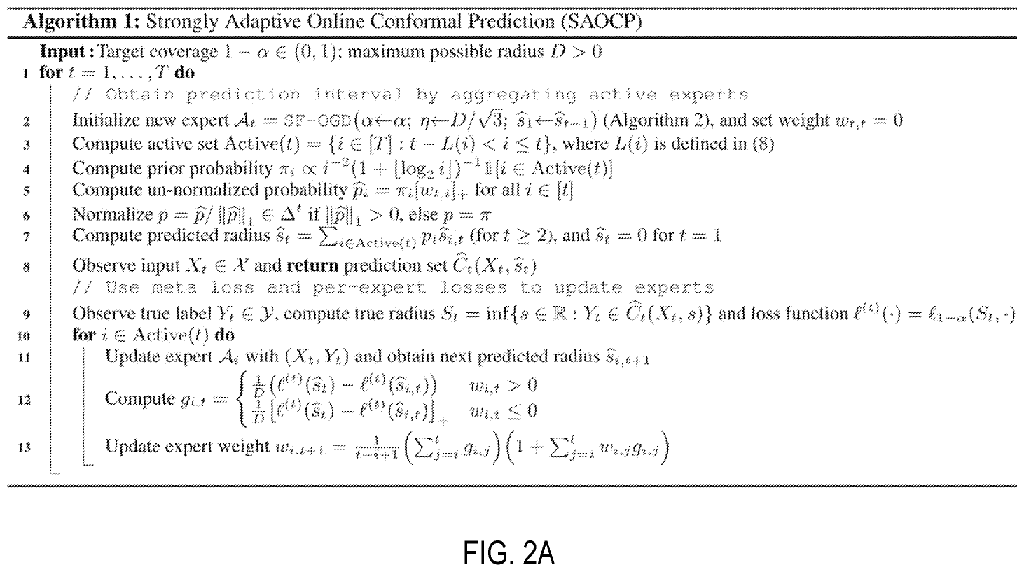

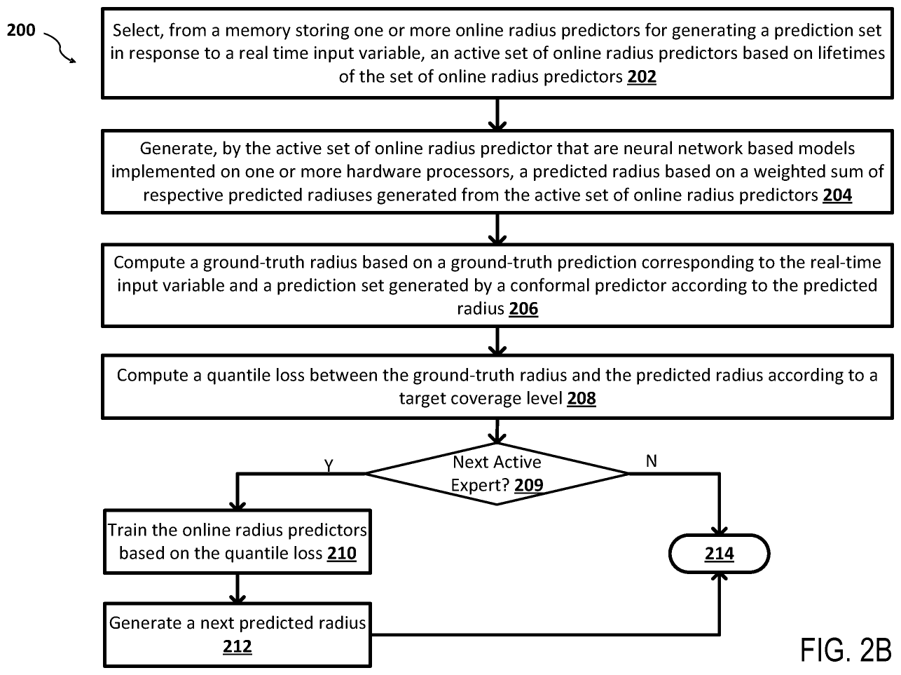

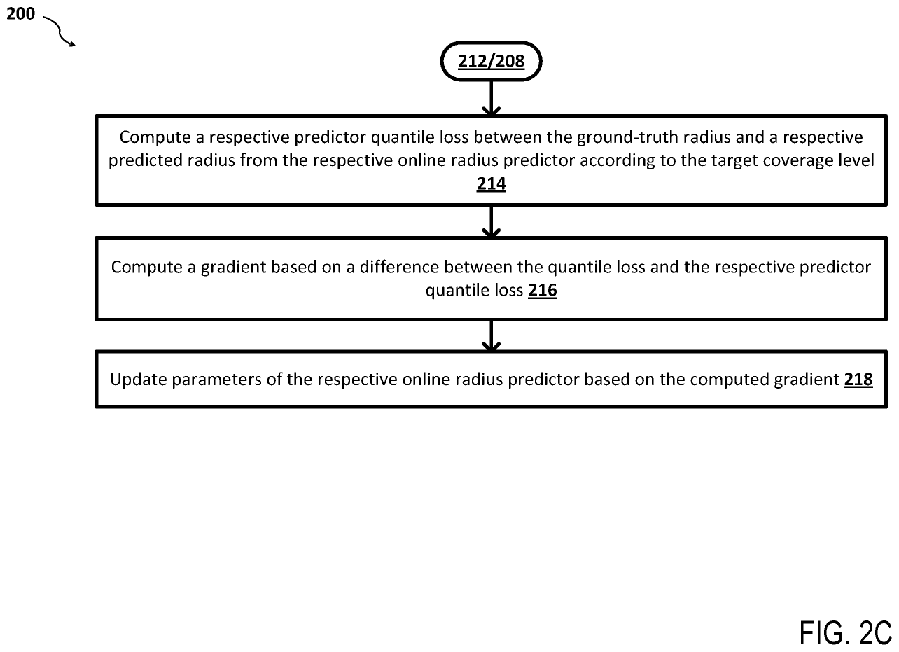

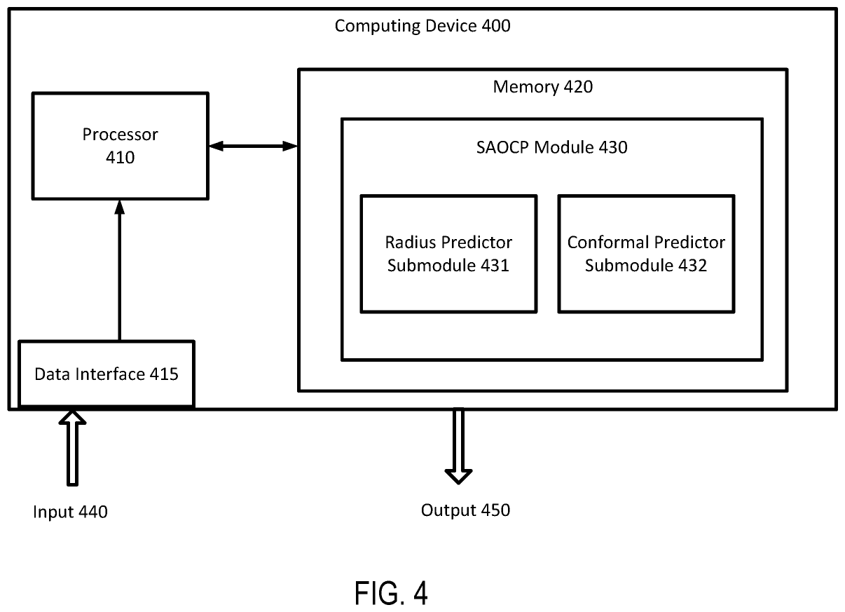

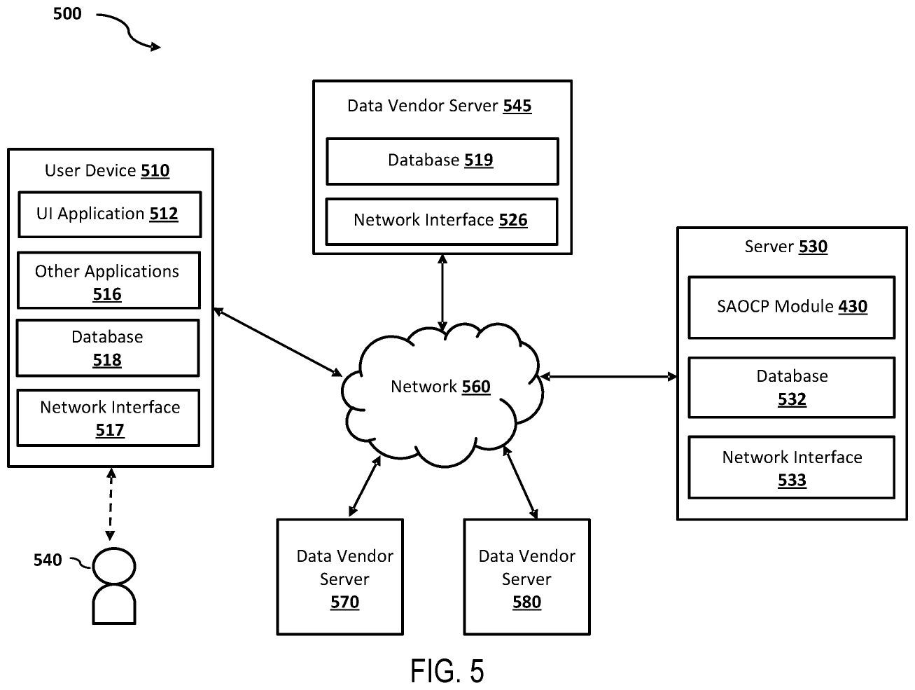

FIG. 2A is an example pseudo code segment illustrating an operation of the SAOCP framework shown in FIG. 1, and FIGS. 2B-2C provides an example logic flow diagram 200 illustrating a method of adaptive online conformal predicting based on the SAOCP framework 100, according to some embodiments described herein. One or more of the processes of method 200 may be implemented, at least in part, in the form of executable code stored on non-transitory, tangible, machine-readable media that when run by one or more processors may cause the one or more processors to perform one or more of the processes. In some embodiments, method 200 corresponds to the operation of the SAOCP module 430 (e.g., FIGS. 4-5) that generates an output of a prediction set in response to a real-time input observation.

As illustrated, the method 200 includes a number of enumerated steps, but aspects of the method 200 may include additional steps before, after, and in between the enumerated steps. In some aspects, one or more of the enumerated steps may be omitted or performed in a different order.

At step 202, from a memory (e.g., 420 in FIG. 4) storing one or more online radius predictors (e.g., 110a-n in FIG. 1, or 431 in FIG. 4) for generating a prediction set in response to a real time input variable (e.g., 105a in FIG. 1), an active set (e.g., 130 in FIG. 1) of online radius predictors are selected based on lifetimes of the set of online radius predictors. Specifically, the one or more online radius predictors may be configured based on the target coverage level 1-a for predicting the prediction set in response to the real-time input variable.

For example, at each time step, a new radius predictor [symbol] ₜ may be instantiated with an active interval, e.g., corresponding to line 2 of Alg. 1 in FIG. 2A. Additional details of initializing each new radius predictor may be described in the SF-OGD method in FIGS. 3A-3B.

In one implementation, for each online radius predictor (including the newly initialized radius predictor), a respective lifetime based on a current time instance is computed, e.g., according to Eq. (1). The active set of online radius predictors is then selected at the current time instance based on lifetimes of the set of online radius predictors from the current time instance, e.g., corresponding to line 3 of Alg. 1 in FIG. 2A.

At step 204, the active set of online radius predictors may generate a predicted radius (e.g., 116 in FIG. 1) based on a weighted sum of respective predicted radiuses (e.g., 116a-b in FIG. 1) generated from the active set of online radius predictors, e.g., according to Eq. (2). In one implementation, the respective predicted radiuses are weighed by respective normalized probabilities indicating respective online radius predictors in the active set are active at a current time instance. For example, for each online radius predictor in the active set, a prior probability that the respective online radius predictor is active at the current time instance may be computed, e.g., according to line 4 of Alg. 1 in FIG. 2A. An un-normalized probability based at least part on the prior probability and weights of the respective conformal predictor at the current time instance, e.g., according to line 5 of Alg. 1. A normalized probability indicating that the respective online radius predictor is active at the current time instance, from the un-normalized probability, e.g., according to line 6 of Alg. 1.

In one embodiment, a prediction set (e.g., 118 in FIG. 1) may then be generated by a conformal predictor (e.g., 150 in FIG. 1) according to the predicted radius generated from steps 202-204.

In steps 206-218, a meta loss and per-expert losses are computed to update the experts (radius predictors). At step 206, a ground-truth radius may be computed based on a ground-truth prediction corresponding to the real-time input variable and a prediction set (e.g., 118 in FIG. 1) generated by a conformal predictor (e.g., 150 in FIG. 1) according to the predicted radius (e.g., 116 in FIG. 1), e.g., according to line 9 of Alg. 1 in FIG. 2A.

At step 208, a quantile loss (e.g., 120 in FIG. 1) may be computed between the ground-truth radius and the predicted radius according to a target coverage level, e.g., according to line 9 of Alg. 1 in FIG. 2A and Eq. (3).

For all the online radius predictors in the active set, the online radius predictors are trained based on the quantile loss at step 210. The trained respective online radius predicator may then generate a next predicted radius at step 212, e.g., according to line 11 of Alg. 1 in FIG. 2A. Each trained online radius predictor may generate the next radius using SF-OGD as further described in relation to FIGS. 3A-3B. If there is another radius predictor in the active set 209, method 200 may proceed to step 210, otherwise, method 200 may proceed to step 214.

At step 214, for each online radius predictor in the active set, a respective predictor quantile loss is computed between the ground-truth radius and a respective predicted radius from the respective online radius predictor according to the target coverage level, and then at step 216, a gradient is computed based on a difference between the quantile loss and the respective predictor quantile loss corresponding to the respective radius predictor, e.g., according to line 12 of Alg. 1 in FIG. 2A.

At step 218, updating parameters of the respective online radius predictor based on the computed gradient, e.g., according to line 13 of Alg. 1 in FIG. 2A.

FIG. 3A is an example pseudo code segment illustrating an operation of the SF-OGD method for initializing each online radius predictor, and FIG. 3B provides an example logic flow diagram 300 illustrating a method of generating a next predicted radius for the next timestep based on the SF-OGD, according to some embodiments described herein. One or more of the processes of method 300 may be implemented, at least in part, in the form of executable code stored on non-transitory, tangible, machine-readable media that when run by one or more processors may cause the one or more processors to perform one or more of the processes. In some embodiments, method 300 corresponds to the operation of the SAOCP module 430 (e.g., FIGS. 4-5) that generates an output of a prediction set in response to a real-time input observation.

As illustrated, the method 300 includes a number of enumerated steps, but aspects of the method 300 may include additional steps before, after, and in between the enumerated steps. In some aspects, one or more of the enumerated steps may be omitted or performed in a different order.

At step 302, the real-time input variable (e.g., 105a in FIG. 1) may be received, at a current time instance, e.g., according to line 2 of Alg. 2 in FIG. 3A.

At step 304, each respective online radius predictor (e.g., 110a-b in FIG. 1) in the active set (e.g., 130 in FIG. 1) and the conformal predictor (e.g., 150 in FIG. 1) may generate a respective prediction set (e.g., 118 in FIG. 1) in response to the real-time input variable, e.g., according to line 3 of Alg. 2 in FIG. 3A. The prediction set may be generated based on a predicted radius generated by the online radius predictors in the active set.

At step 306, a respective ground-truth radius may be computed based on the ground-truth prediction and the respective prediction set, e.g., according to line 4 of Alg. 2 in FIG. 3A.

At step 308, for the radius predictor, a respective quantile loss may be computed between the respective ground-truth radius and the respective predicted radius according to the target coverage level, e.g., according to line 5 of Alg. 2 in FIG. 3A and Eq. (3).

At step 310, the respective predicted radius may be updated for a next time instance based on the respective predicted radius at the current time instance and a gradient of the respective quantile loss, e.g., according to line 6 of Alg. 2 in FIG. 3A.

For example, the predicted radius for the next time step may be updated by:

$${\hat{s}}_{t + 1} = {\hat{s}}_{t} - η \frac{∇ {ℓ}^{( t )} ( {\hat{s}}_{t} )}{\sqrt{{\sum }_{i = 1}^{t} {‖ ∇ {ℓ}^{( i )} ( {\hat{s}}_{i} ) ‖}_{2}^{2}}} \qquad ( 6 )$$

Method 300 of the SF-OGD may be implemented as a strong regret minimization algorithm itself. In other words, SF-OGD can also be run independently (over [T]) as an algorithm for online conformal prediction to generate the prediction set at step 304 and then update the predicted radius at step 310 at each time step. On the quantile loss (3) (executed over the full horizon [T] with learning rate η=Θ(D); η=D/\sqrt{3} is optimal), SF-OGD enjoys an anytime regret guarantee:

$$Reg ( t ) \leq 𝒪 ( D \sqrt{t} ) for all t ∈ [ T ] . \qquad ( 7 )$$

Further, the SAOCP method 200 in FIGS. 2B-2C achieves a SARegret bound by instantiating SAOCP 200 with SF-OGD as the experts, thereby plugging the regret bound for SF-OGD into the SARegret guarantee for SAOCP. Specifically, the SAOCP method 200 (Alg. 1 in FIG. 2A) achieves the following SARegret bound simultaneously for all lengths k∈[T]:

$$SAReg ( T , k ) \leq 15 D \sqrt{k ( log T + 1 )} \leq 𝒪 ( D \sqrt{k} ) . \qquad ( 8 )$$

The [symbol] (D\sqrt{k}) rate achieved by SAOCP is near-optimal for general online convex optimization problems, due to the standard regret lower bound Ω(D\sqrt{k}) over any fixed interval of length k.

Therefore, the SARegret guarantee of SAOCP method 200 improves substantially over the traditional FACI algorithm (Gibbs & Candès, 2022), an extension of ACI. Concretely, the SARegret bound for SAOCP method 200 holds simultaneously for all lengths k. By contrast, FACI only achieves SAReg(T, k)≤ [symbol] (D²/η+ηk), where η>0 is their meta-algorithm learning rate. This can imply the same rate [symbol] (D\sqrt{k}) for a single k by optimizing η, but not multiple values of k simultaneously.

Also, in terms of algorithm styles, while both SAOCP and FACI are meta-algorithms that maintain multiple experts (base algorithms), a main difference between them is that all experts in FACI differ in their learning rates and are all active over [T], whereas experts in SAOCP differ in their active intervals.

FIG. 4 is a simplified diagram illustrating a computing device implementing a the SAOCP framework described herein in FIGS. 1-3B, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for a conformal prediction module 430 that may be used to implement and/or emulate the systems and models, and/or to implement any of the methods described further herein. The conformal prediction module 430 may receive input 440 such as an input training data (e.g., documents and/or photos) via the data interface 415 and generate an output 450 which may be a prediction set for conformal prediction models.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a photo, a question, a sentence, an article, and a document, from a user via the user interface.

In some embodiments, the SAOCP module 430 is configured to provide an output 450 in the form of an online conformal prediction set (e.g., 118 in FIG. 1). The SAOCP module 430 may further include one or more radius predictor submodules 431 (e.g., similar to 110a-n in FIG. 1), and a conformal predictor submodule 432 (e.g., similar to 150 in FIG. 1). In one embodiment, the SAOCP module 430 and its submodules 431 and 432 may be implemented by hardware, software and/or a combination thereof.

In one embodiment, the SAOCP module 430 may store parameters and/or weights of the submodules 431 and 432. The SAOCP module 430 may further comprise processor-executable instructions to perform the method 200 illustrated in FIGS. 2B-2C. The radius predictor submodule 431 may comprise processor-executable instructions to perform the SF-OGD method 300 in FIG. 3B.

In one embodiment, the SAOCP module 430 and one or more of its submodules 431 and 432 may be implemented via an artificial neural network. The neural network comprises a computing system that is built on a collection of connected units or nodes, referred as neurons. Each neuron receives an input signal and then generates an output by a non-linear transformation of the input signal. Neurons are often connected by edges, and an adjustable weight is often associated to the edge. The neurons are often aggregated into layers such that different layers may perform different transformations on the respective input and output transformed input data onto the next layer. Therefore, the neural network may be stored at memory 420 as a structure of layers of neurons, and parameters describing the non-linear transformation at each neuron and the weights associated with edges connecting the neurons.

In one embodiment, the neural network based SAOCP module 430 and one or more of its submodules 431 and 432 may be trained by updating the underlying parameters of the neural network based on a loss (e.g., the quantile loss computed in Eq. (3)) from the training process of dense retrievers. For example, the loss is a metric that evaluates how far away a neural network model generates a predicted output value from its target output value (also referred to as the “ground-truth” value), e.g., the “truth output” label 105b in FIG. 1. Given the loss computed from the training process of the dense retrievers, the negative gradient of the loss function is computed with respect to each weight of each layer individually. Such negative gradient is computed one layer at a time, iteratively backward from the last layer to the input layer of the neural network. Parameters of the neural network are updated backwardly from the last layer to the input layer (backpropagating) based on the computed negative gradient to minimize the loss. The backpropagation from the last layer to the input layer may be conducted for a number of training samples in a number of training epochs. In this way, parameters of the neural network may be updated in a direction to result in a lesser or minimized loss, indicating the neural network has been trained to generate a predicted output value closer to its target output value.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified block diagram of a networked system suitable for implementing the strongly adaptive online learning framework described in FIG. 1 and other embodiments described herein. In one embodiment, block diagram 500 shows a system including the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 100 described in FIG. 1, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating an output, e.g., a prediction set, from the server 530 and display the message via the UI application 512. In other embodiments, user device 510 may include additional or different modules having specialized hardware and/or software as required.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view a prediction output.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets, including Wikipedia, CommonCrawl, Open-Domain Question Answering datasets, to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the conformal prediction module 130 and its submodules described in FIG. 1. In some implementations, the conformal prediction module 130 may receive data from database 519 at the data vendor server 545 via the network 560 to generate prediction sets for training conformal prediction models. The generated prediction sets may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the conformal prediction module 130. In one implementation, the database 532 may store previously generated prediction output/prediction set, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Applications of SAOCP Framework

In some embodiments, the SAOCP framework 100 shown in FIG. 1 (and additional embodiments described in relation to FIGS. 2A-5) may be applied in various online uncertainty quantification tasks, e.g., time series forecasting and image classification under distribution shift.

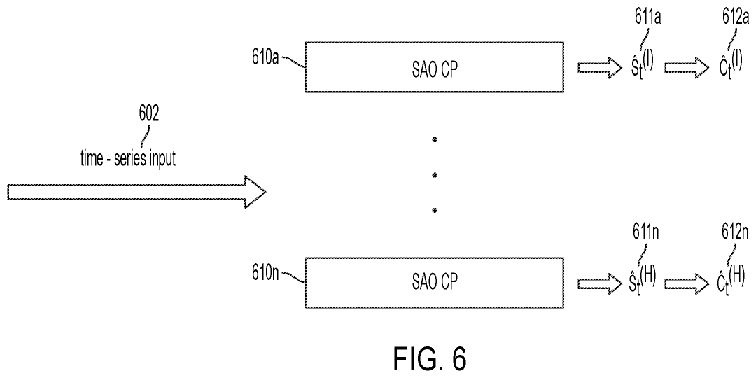

FIG. 6 is a simplified diagram illustrating aspects of applying the SAOCP framework to time series forecasting, according to embodiment described herein. The time series forecasting setting may employ H copies of the SAOCP framework 610a-n (each being similar to the SAOCP framework 100 in FIG. 1) in parallel to generate a prediction set corresponding to each data point predicted for a future time step. For example, in a multi-horizon time series forecasting with setting with real-valued observations input 602 {yₜ}_{t≥1}∈ [symbol] , where the base predictor \hat{f} uses the history Xₜ:=y_{1:t} to predict H steps into the future, i.e. \hat{f}(Xₜ)={\hat{f}^{(h)}(Xₜ)}_{h∈[H]}={ŷₜ₊ₕ^{(h)}}_{h∈[H]}, where ŷₜ₊ₕ^{(h)} is a prediction for yₜ₊ₕ. Using \hat{f}(Xₜ), each SAOCP 610a-n may produce the prediction sets 612a-n as a fixed-width prediction intervals:

$${\hat{C}}_{t}^{( h )} ( {X}_{t} , {\hat{s}}_{t}^{( h )} ) := [ {\hat{y}}_{t + h}^{( h )} - {\hat{s}}_{t}^{( h )} , {\hat{y}}_{t + h}^{( h )} + {\hat{s}}_{t}^{( h )} ] ,$$

Where ŝₜ^{(h)} 611a-n is predicted by an independent copy of the SAOCP framework 100 for each h∈[H] (so that there are H such algorithms in parallel). The online setting may be formed using a standard rolling window evaluation loop, wherein each batch consists of predicting all H intervals {Ĉ_{ty}^{(h)}}_{h∈[H]}, observing all H true values {yₜ₊ₕ}_{h∈[H]}, and moving to the next batch by setting t→t+H. For each h∈[H], only yₜ₊ₕ is evaluated against one interval Ĉₜ^{(h)}(Xₜ,ŝₜ^{(h)}). After the evaluation is done, all pairs {(yₜ₊ₖ, ŷₜ₊ₖ^{(h)})}_{k∈[H]} are compared to update ŝₜ^{(h)}→ŝ_{t+H}^{(h)}.

In one embodiment, each SAOCP 610a-n may employ base predictors (e.g., similar to 150 in FIG. 1) such as
1. LGBM: A model which uses gradient boosted trees to predict ŷₜ₊ₕ^{(h)}=\hat{f}^{(h)}(y_{t-L+1}, . . . >yₜ). This approach attains strong performance on many time series benchmarks (see Elsayed et al., Do we really need deep learning models for time series forecasting?, arXiv 2101.02118, 2021; and Bhatnagar et al., Merlion: A machine learning library for time series, arXiv 2109.09265, 2021).
2. ARIMA(10, d*, 10): The classical AutoRegressive Integrated Moving Average stochastic process model for a time series, where the difference order d* is chosen by KPSS stationarity test (See Kwiatkowski et al., Testing the null hypothesis of stationarity against the alternative of a unit root: How sure are we that economic time series have a unit root?, Journal of Econometrics, 54(1): 159-178, 1992).
3. Prophet (Taylor et al., Forecasting at scale, PeerJ Preprints, 5(e3190v2), 2017): A popular Bayesian model which directly predicts the value y as a function of time, i.e. ŷₜ=\hat{f}(t).

Example datasets for time series forecasting may include 5111 time series: the hourly (414 time series), daily (4227 time series), and weekly (359 time series) subsets of the M4 Competition, a dataset of time series from many domains including industries, demographics, environment, finance, and transportation (Makridakis et al., The m4 competition: Results, findings, conclusion and way forward, International Journal of Forecasting, 34(4):802-808, 2018); and NN5, a dataset of 111 time series of daily banking data (Ben Taieb et al., A review and comparison of strategies for multi-step ahead time series forecasting based on the nn5 forecasting competition. Expert Systems with Applications, 39(8):7067-7083, 2012). Each time series is normalized to lie in [0, 1].

In the example experiments, horizons H of 24, 30, and 26 for hourly, daily, and weekly data, are adopted, respectively. Each time series of length L is split into a training set of length L-120 with 80% for training the base predictor and 20% for initializing the UQ methods, and a test set of length 120 to test the UQ methods.

For each experiment, the following statistics is averaged across all time series: global coverage, median width, worst-case local coverage error

$$L C {E}_{k} := {max}_{[ τ , τ + k - 1 ] ⊆ [ 1 , T ]} \vert α - \frac{1}{k} {\sum }_{t = τ}^{τ + k - 1} e r {r}_{t} \vert ,$$

and strongly adaptive regret SAReg(T, k), referred to as SARegₖ. In all cases, an interval length of k=20 is used. The average mean absolute error (MAE) of each base predictor is also used as a performance metric as shown in FIGS. 8-9.

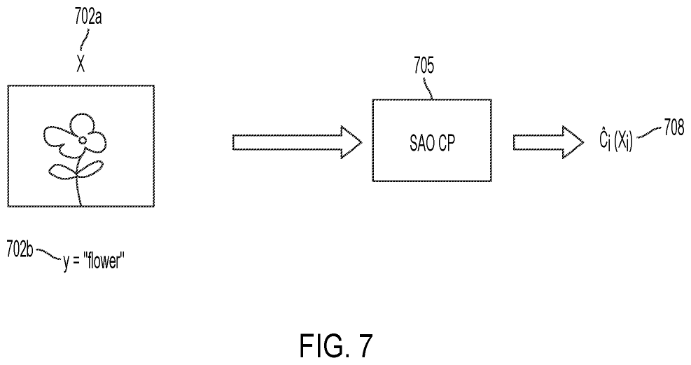

FIG. 7 is a simplified diagram illustrating aspects of applying the SAOCP framework to image classification under distribution shift, according to embodiment described herein. The SAOCP framework may be applied to image classification to maintain coverage when the underlying distribution shifts in a systematic manner. For example, a ResNet-50 classifier (He et al., Deep residual learning for image recognition, In proceedings of IEEE Conference on Computer Vision and Pattern Recognition (CVPR), pp. 770-778, 2016) pre-trained on ImageNet and implemented in PyTorch (Paszke et al., Pytorch: An imperative style, high-performance deep learning library. In Advances in Neural Information Processing Systems 32, pp. 8024-8035, 2019) may be employed. Here, the input x∈X 702a is an image, and y∈Y=[m] 702b is its class. To construct structured distribution shifts away from the training distribution, TinyImageNet-C and ImageNet-C (Hendrycks et al., Benchmarking neural network robustness to common corruptions and perturbations, In proceedings of International Conference on Learning Representations, 2019), which are corrupted versions of the TinyImageNet (m=200 classes) and ImageNet (m=1000 classes) test sets designed to evaluate model robustness. These corrupted datasets apply 15 visual corruptions at 5 different severity levels to each image in the original test set.

Two regimes may be considered: sudden shifts where the corruption level alternates between 0 (the base test set) and 5, and gradual shifts where the corruption level increases in the order of {0, 1, . . . , 5}. 500 data points are randomly sampled from the input image 702a for each corruption level before changing to the next level.

The SAOCP framework 705 may generate a prediction set 708 for each data point in the input image 702a as follows. Let \hat{f}: [symbol] ^{d}→Δ^{m} be a classifier that outputs a probability distribution on the m-simplex. At each t, Uₜ˜Unif[0,1] is sampled and let

$${S}_{t} ( x , y ) = λ \sqrt{{[ {k}_{y} - {k}_{reg} ]}_{+}} + {U}_{t} {\hat{f}}_{y} ( x ) + {\sum }_{i = 1}^{{k}_{y} - 1} {\hat{f}}_{π ( i )} ( x ) {\hat{C}}_{t} ( {X}_{t} ) = \{ y : {S}_{t} ( {X}_{t} , y ) \leq \} {\hat{s}}_{t}$$

where π is the permutation that ranks \hat{f}ₓ in decreasing order, π(k_{y})=y, and λ and k_{reg} are regularization parameters designed to reduce the size of the prediction set. For TinyImageNet, λ=0.01 and K_{reg}=20. For ImageNet, λ=0.01 and K_{reg}=10.

When evaluating the UQ methods, the local coverage and prediction set size (PSS) of each method are considered using an interval length of k=100,

$$LocalCov ( t ) = \frac{1}{100} {\sum }_{i = t}^{t + 99} 1 [ {Y}_{i} ∈ {\hat{C}}_{i} ( {X}_{i} ) ]$$

$$LocalPSS ( t ) = \frac{1}{100} {\sum }_{i = t}^{t + 99} [ {\hat{C}}_{i} ( {X}_{i} ) ]$$

the local coverage to a target of 1−α, while the local PSS is compared to the 1−α empirical quantile of the oracle set sizes PSS*ₜ=|{y:Sₜ (Xₜ,y)≤Sₜ(Xₜ, Yₜ)}|. These targets are the “best fixed” values in each window. The worstcase local coverage error LCE₁₀₀ is also considered.

FIGS. 8-9 provide example data performance of time series forecasting using SAOCP framework illustrated in FIG. 6, according to embodiments described herein. Results are shown in the tables in FIGS. 8-9 on M4 Hourly and M4 Daily in Tables 1, 2. Example baseline methods compared with the SAOCP include:
(i) SCP: standard Split Conformal Prediction (Vovk et al., A tutorial on conformal prediction, Journal of Machine Learning Research, 9(3), 2005) adapted to the online setting, which simply predicts the (1−α)-quantile of the past radii. SCP does not admit a valid coverage guarantee in our settings as the data may not be exchangeable in general;
(ii) NExCP: Non-Exchangeable SCP (Barber et al., Conformal prediction beyond exchangeability, arXiv. 2202.13415, 2022) a variant of SCP that handles non-exchangeable data by reweighting. We follow their recommendations and use an exponential weighting scheme that upweights more recent observations;
(iii) FACI (Gibbs et al., Conformal inference for online prediction with arbitrary distribution shifts, arXiv. 2208.08401, 2022) with their specific “quantile parametrization” (4), and score function \tilde{S}ₜ corresponding to our choice of Ĉₜ;
(iv) FACI-S: Generalized version of FACI applied to predicting the radius Ŝₜ's on our choice of Ĉₜ directly.
   The target coverage level to be the standard 1−α=90%.

As shown in FIGS. 8-9, SAOCP consistently achieves global coverage in (0.85, 0.95), and it obtains the best or second-best interval width, local coverage error, and strongly adaptive regret for all base predictors on all 3 M4 datasets. FACI-S generally achieves better LCEₖ and SARegₖ than FACI, showing the benefits of predicting ŝₜ₊₁ directly, rather than as a quantile of S₁, . . . , Sₜ. The relative performance of FACI-S and SF-OGD varies, though FACI-S is usually a bit better. However, SAOCP consistently achieves better LCEₖ and SARegₖ than both FACI-S and SF-OGD.

There are multiple instances where all of SCP/NExCP/FACI fail to attain global coverage in (0.85, 0.95) (FIG. 9). The base predictor's MAE is at least 0.13 in all these cases, suggesting an advantage of predicting ŝₜ₊₁ directly as in SF-OGD/SAOCP when the underlying base predictor is inaccurate.

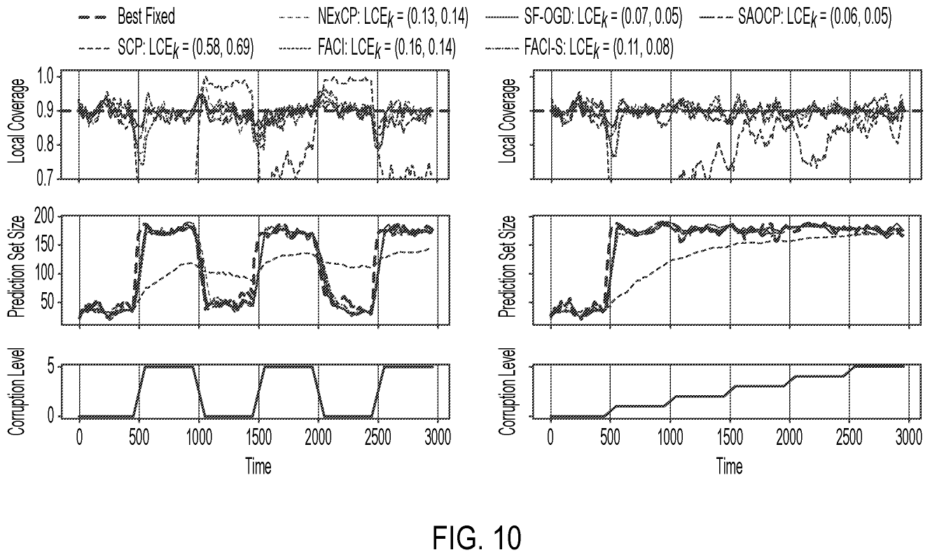

FIG. 10 is an example data plot illustrating the data performance of image classification using SAOCP framework, according to embodiments described herein. The UQ methods are evaluated on TinyImageNet and TinyImageNet-C in FIG. 10. In both sudden and gradual distribution shift, the local coverage of SAOCP and SF-OGD remains the closest to the target of 0.9. The difference is more notable when the distribution shifts suddenly. When the distribution shifts more gradually, NExCP, FACI, and FACI-S have worse coverage than SAOCP and SF-OGD at the first change point, which is where the largest change in the best set size occurs.

All methods besides SCP predict sets of similar sizes, though FACI's, FACI-S's, and NExCP's prediction set sizes adapt more slowly to changes in the best fixed size (e.g., t E [500, 700] for gradual shift in FIG. 2). On TinyImageNet, SAOCP obtains slightly better local coverage than SF-OGD, and they both have similar prediction set sizes (FIG. 10).

Embodiments described herein provide an improved conformal prediction method using models which minimize regret to provide a prediction set with valid coverage and small regret.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for adaptive online conformal predicting, comprising:
selecting, from a memory storing one or more online radius predictors for generating a prediction set in response to a real time input variable, an active set of online radius predictors based on lifetimes of the set of online radius predictors;
generating, by the active set of online radius predictor that are neural network based models implemented on one or more hardware processors, a predicted radius based on a weighted sum of respective predicted radiuses generated from the active set of online radius predictors;
computing a ground-truth radius based on a ground-truth prediction corresponding to the real-time input variable and a prediction set generated by a conformal predictor according to the predicted radius;
computing a quantile loss between the ground-truth radius and the predicted radius according to a target coverage level; and
for the online radius predictors in the active set:
training the online radius predictors based on the quantile loss, and generating, by the trained respective online radius predicator, a next predicted radius.

2. The method of claim 1, further comprising:
configuring the one or more online radius predictors based on the target coverage level for predicting the prediction set in response to the real-time input variable,
wherein each online radius predictor generates a respective predicted radius in response to the real-time input variable.

3. The method of claim 1, wherein the active set of online radius predictors is selected by:
computing, for each online radius predictor, a respective lifetime based on a current time instance; and
selecting the active set of online radius predictors at the current time instance based on lifetimes of the set of online radius predictors from the current time instance.

4. The method of claim 1, wherein the respective predicted radiuses are weighed by respective normalized probabilities indicating respective online radius predictors in the active set are active at a current time instance.

5. The method of claim 4, wherein the respective normalized probabilities are computed by:
for each online radius predictor in the active set:
computing a prior probability that the respective online radius predictor is active at the current time instance,
computing an un-normalized probability based at least part on the prior probability and weights of the respective conformal predictor at the current time instance, and
computing, from the un-normalized probability, a normalized probability indicating that the respective online radius predictor is active at the current time instance.

6. The method of claim 1, further comprising:
computing a respective predictor quantile loss between the ground-truth radius and a respective predicted radius from the respective online radius predictor according to the target coverage level;
computing a gradient based on a difference between the quantile loss and the respective predictor quantile loss; and
updating parameters of the respective online radius predictor based on the computed gradient.

7. The method of claim 1, wherein each respective predicted radius is generated by a respective online radius predictor in the active set at a current time instance by:
receiving, at a current time instance, the real-time input variable;
generating, by the respective online radius predictor and the conformal predictor, a respective prediction set in response to the real-time input variable;
computing a respective ground-truth radius based on the ground-truth prediction and the respective prediction set;
computing a respective quantile loss between the respective ground-truth radius and the respective predicted radius according to the target coverage level; and
updating the respective predicted radius for a next time instance based on the respective predicted radius at the current time instance and a gradient of the respective quantile loss.

8. The method of claim 1, further comprising:
receiving, via a communication interface, a first time series comprising at least the real time input variable at the current time instance;
generating, by trained online radius predicators and the conformal predictor, predicted intervals for one or more future time instances,
wherein each predicted interval corresponds to a future time instance and has a width based on the predicted radius at the current time instance.

9. The method of claim 1, wherein the quantile loss is computed based at least in part on a difference between the predicted radius and the ground-truth radius, weighed by the target coverage level.

10. The method of claim 1, wherein the training the online radius predictors based on the quantile loss comprises:
computing a gradient based on a difference between a first quantile loss corresponding to the predicted radius and a second quantile loss corresponding to a respective predicted radius generated by a particular online radius predictor from the active set; and
updating parameters of the particular online radius predictor based on the gradient.

11. A system for adaptive online conformal predicting, the system comprising:
a memory storing one or more online radius predictors for generating a prediction set in response to a real time input variable, and a plurality of processor-executable instructions; and
one or more hardware processors that execute the instructions to perform operations comprising:
selecting an active set of online radius predictors based on lifetimes of the set of online radius predictors;
generating, by the active set of online radius predictor that are neural network based models implemented on one or more hardware processors, a predicted radius based on a weighted sum of respective predicted radiuses generated from the active set of online radius predictors;
computing a ground-truth radius based on a ground-truth prediction corresponding to the real-time input variable and a prediction set generated by a conformal predictor according to the predicted radius;
computing a quantile loss between the ground-truth radius and the predicted radius according to a target coverage level; and
for the online radius predictors in the active set:
training the online radius predictors based on the quantile loss, and
generating, by the trained respective online radius predicator, a next predicted radius.

12. The system of claim 11, wherein the operations further comprise:
configuring the one or more online radius predictors based on the target coverage level for predicting the prediction set in response to the real-time input variable,
wherein each online radius predictor generates a respective predicted radius in response to the real-time input variable.

13. The system of claim 11, wherein the active set of online radius predictors is selected by:
computing, for each online radius predictor, a respective lifetime based on a current time instance; and
selecting the active set of online radius predictors at the current time instance based on lifetimes of the set of online radius predictors from the current time instance.

14. The system of claim 11, wherein the respective predicted radiuses are weighed by respective normalized probabilities indicating respective online radius predictors in the active set are active at a current time instance.

15. The system of claim 14, wherein the respective normalized probabilities are computed by:
for each online radius predictor in the active set:
computing a prior probability that the respective online radius predictor is active at the current time instance,
computing an un-normalized probability based at least part on the prior probability and weights of the respective conformal predictor at the current time instance, and
computing, from the un-normalized probability, a normalized probability indicating that the respective online radius predictor is active at the current time instance.

16. The system of claim 11, wherein the operations further comprise:
computing a respective predictor quantile loss between the ground-truth radius and a respective predicted radius from the respective online radius predictor according to the target coverage level;
computing a gradient based on a difference between the quantile loss and the respective predictor quantile loss; and
updating parameters of the respective online radius predictor based on the computed gradient.

17. The system of claim 11, wherein each respective predicted radius is generated by a respective online radius predictor in the active set at a current time instance by:
receiving, at a current time instance, the real-time input variable;
generating, by the respective online radius predictor and the conformal predictor, a respective prediction set in response to the real-time input variable;
computing a respective ground-truth radius based on the ground-truth prediction and the respective prediction set;
computing a respective quantile loss between the respective ground-truth radius and the respective predicted radius according to the target coverage level; and
updating the respective predicted radius for a next time instance based on the respective predicted radius at the current time instance and a gradient of the respective quantile loss.

18. The system of claim 11, wherein the operations further comprise:
receiving, via a communication interface, a first time series comprising at least the real time input variable at the current time instance; and
generating, by trained online radius predicators and the conformal predictor, predicted intervals for one or more future time instances,
wherein each predicted interval corresponds to a future time instance and has a width based on the predicted radius at the current time instance.

19. The system of claim 11, wherein the quantile loss is computed based at least in part on a difference between the predicted radius and the ground-truth radius, weighed by the target coverage level.

20. A non-transitory processor-readable storage medium storing a plurality of processor-executable instructions for adaptive online conformal predicting, the instructions being executed by one or more hardware processors to perform operations comprising:
selecting, from a memory storing one or more online radius predictors for generating a prediction set in response to a real time input variable, an active set of online radius predictors based on lifetimes of the set of online radius predictors;
generating, by the active set of online radius predictor that are neural network based models implemented on one or more hardware processors, a predicted radius based on a weighted sum of respective predicted radiuses generated from the active set of online radius predictors;
computing a ground-truth radius based on a ground-truth prediction corresponding to the real-time input variable and a prediction set generated by a conformal predictor according to the predicted radius;
computing a quantile loss between the ground-truth radius and the predicted radius according to a target coverage level; and
for the online radius predictors in the active set:
training the online radius predictors based on the quantile loss, and
generating, by the trained respective online radius predicator, a next predicted radius.
